(19) United States
(12) Patent Application Publication
(10) Pub. No.: US 2018/0053932 A1
(43) Pub. Date: Feb. 22, 2018

(54) CATHODE SLURRY COMPOSITION OF ALL-SOLID-STATE ION BATTERY AND CATHODE OF ALL-SOLID-STATE ION BATTERY COMPRISING THE SAME

(71) Applicant: Hyundai Motor Company, Seoul (KR)

(72) Inventor: Kyoung Jin JEONG, Seoul (KR)

(73) Assignee: Hyundai Motor Company, Seoul (KR)

(21) Appl. No.: 15/376,425

(22) Filed: Dec. 12, 2016

(30) Foreign Application Priority Data
Aug. 18, 2016 (KR) 10-2016-0104742

(51) Int. Cl. H01M 4/36; H01M 10/0585; H01M 10/0562; H01M 4/62

(52) U.S. Cl. CPC H01M 4/364; H01M 10/0585; H01M 2004/028; H01M 4/622; H01M 10/0562

(57) ABSTRACT

A cathode slurry composition of an all-solid-state ion battery and a cathode of an all-solid-state ion battery comprising the same are provided herein. More particularly, the cathode slurry composition—and the cathode comprising the cathode slurry composition thereof comprises a binder that can be completely dissolved in the cathode slurry by using hydroxylated nitrile butadiene rubber having a nitrile content of about 20 wt % to about 3 wt % as a binder and a mixture of three components having different polarities as a dispersing solvent. As a result, dispersion and cohesion of these components are largely improved in the slurry.

### CROSS-REFERENCE TO RELATED APPLICATION

This application claims under 35 U.S.C. § 119(a) the benefit of Korean Patent Application No. 10-2016-0104742, filed on Aug. 18, 2016, the entire contents of which are incorporated herein by reference for all purposes.

### BACKGROUND

### Technical Field

The present disclosure relates to a cathode slurry composition of an all-solid-state ion battery and a cathode of an all-solid-state ion battery including the same. More particularly, it relates to a cathode slurry composition of an all-solid-state ion battery and a cathode of an all-solid-state ion battery including the same in which a binder can be completely dissolved in the cathode slurry. By using hydroxylated nitrile butadiene rubber having a nitrile content of 20 to 43 wt % as a binder and a mixture of three components having different polarities as a dispersing solvent, dispersion and bonding force of the components contained in the slurry are largely improved over prior art compositions and cathodes.

### Background Art

Today, secondary batteries have been widely used from large devices such as a vehicle and a power storage system to small devices such as a mobile phone, a camcorder, and a laptop. As a secondary battery, a lithium secondary battery has an advantage of large capacity per unit area as compared with a Ni-Mn battery or a Ni-Cd battery. However, a lithium secondary battery can easily overheat, has an energy density of only about 360 Wh/kg, and has a poor output. Thus these batteries are not appropriate as a next-generation battery which may be applied to a vehicle.

As a result, there is increased interest in an all-solid-state ion battery having high output and high energy density. The all-solid-state ion battery includes a cathode containing an active material, a solid electrolyte, a conductive material, a binder, and the like, an anode, and a solid electrolyte interposed between the cathode and the anode.

The solid electrolyte typically contains a sulfide-based solid electrolyte. In some cases when a strong polar solvent, the sulfide-based solid electrolyte may be dissolved or have a decrease in ion conductance. Due to these characteristics, a non-polar or weakly polar solvent can to be used.

However, when using a non-polar or weakly polar solvent, the type of binder that can be added is extremely limiting. For example, when a nitrile-based binder is used with a non-polar or weakly polar solvent, the binder is not completely dissolved in the solvent and can not be evenly dispersed in the slurry. Furthermore, cohesion of the components of the slurry deteriorates and the insoluble binder increases resistance in the cathode. As a result, the performance and lifespan of the battery deteriorate.

Accordingly, there is no reactivity with the active material, the solid electrolyte, and the conductive material in the all-solid-state ion battery. Research and development directed at improving dispersion force of the slurry in the electrode by increasing solubility with the binder while maintaining chemical stability is needed.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with prior art.

The inventors of the present invention found that a binder can be completely dissolved in a cathode slurry and dispersion and bonding force of components contained in the slurry can significantly be improved, by using hydroxylated nitrile butadiene rubber having the nitrile content of from about 20 wt % to about 43 wt % (e.g., about 20 wt %, 21, 22, 23, 24, 25, 26, 27, 28, 29, 30, 31, 32, 33, 34, 35, 36, 37, 38, 39, 40, 41, 42, or about 43 wt %) as a binder and using a mixture of three components having different polarities as a dispersing solvent.

More particularly, a first dispersing solvent serves to completely or partially dissolve a binder which may be used in a cathode of an all-solid-state ion battery and to disperse a cathode active material in the cathode, a solid electrolyte, and a conductive material. A second dispersing solvent and a third dispersing solvent serve to completely dissolve the binder and improve dispersion by delaying a precipitation velocity in the dispersing solvent of the cathode active material, the sulfide-based solid electrolyte, and the conductive material.

Therefore, an object of the present invention is to provide a cathode slurry composition for an all-solid-state ion battery which significantly improves solubility of a binder.

Another object of the present invention is to provide a cathode for an all-solid-state ion battery that contains the cathode slurry composition.

Still another object of the present invention is to provide an all-solid-state ion battery including the cathode.

In one aspect, the present invention provides a cathode slurry composition for an all-solid-state ion battery. The cathode slurry composition can include an active material, a conductive material, a sulfide-based solid electrolyte, a binder, and a dispersing solvent. The dispersing solvent can include (a) a first dispersing solvent which is at least one selected from a group consisting of cyclopentyl methyl ether, xylene and heptane; (b) a second dispersing solvent which is at least one selected from a group consisting of tributyl amine (TBA), triethylamine and cyclohexanone; and (c) a third dispersing solvent having dispersion of from about 10 MPa to about 20 MPa (e.g., about 10 MPa, 11, 12, 13, 14, 15, 16, 17, 18, 19 or about 20 MPa) and a polarity index of from about 9 MPa to about 18 MPa (e.g. about 9 MPa, 10, 11, 12, 13, 14, 15, 16, 17, or about 18 MPa.

In another aspect, the present invention provides a cathode for an all-solid-state ion battery including the cathode slurry composition.

In still another aspect, the present invention provides an all-solid-state ion battery including the cathode.

According to the present invention, the cathode slurry composition of the all-solid-state ion battery can largely improve the bonding force and dispersion stability of the components contained in the cathode slurry by using hydroxylated nitrile butadiene rubber having a nitrile content of from about 20 wt % to about 43 wt % (e.g., about 20 wt %, 21, 22, 23, 24, 25, 26, 27, 28, 29, 30, 31, 32, 33, 34, 35, 36, 37, 38, 39, 40, 41, 42, or about 43 wt %) as a binder and a dispersing solvent used by mixing three components having different polarities as a solvent.

An insoluble binder in an existing non-polar solvent can be completely dissolved in the cathode slurry to evenly disperse the active material, the conductive material, and the like. The lithium ion conductivity can be dispersed by preventing ionization of electrolyte elements.

It is also possible to prepare a cathode to which a cathode slurry composition with improved dispersion and bonding force is applied.

It is also possible to improve the performance and charge and discharge characteristics of an all-solid-state ion battery using the cathode and/or the cathode slurry composition described herein.

Other aspects and preferred embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention:

FIG. 1 is a photograph illustrating a result of evaluating solubility of an HNBR binder (34 wt % and 20 wt % of nitrile) for a dispersing solvent in Preparation Example 1 of the present invention.

FIG. 2 is a photograph illustrating a result of evaluating solubility of an HNBR binder (34 wt %, 39 wt %, and 43 wt % of nitrile) for dispersing solvents in Preparation Examples 1A to 1C and 6D of the present invention.

FIG. 3A is a photograph illustrating a result of evaluating solubility of an HNBR binder (34 wt % of nitrile) used in a dispersing solvent in Preparation Example 2 of the present invention.

FIG. 3B is a photograph illustrating a result of evaluating solubility of an HNBR binder (39 wt % of nitrile) used in a dispersing solvent in Preparation Example 2 of the present invention.

FIG. 3C is a photograph illustrating a result of evaluating solubility of an HNBR binder (43 wt % of nitrile) used in a dispersing solvent in Preparation Example 2 of the present invention.

FIG. 4 is a photograph illustrating a result of evaluating solubility of an HNBR binder (34 wt % of nitrile) using dispersing solvents in Preparation Examples 1 to 5 and 7 to 9 of the present invention.

FIG. 5 is a graph illustrating a result of evaluating charge and discharge of an all-solid-state ion battery prepared in Examples 9 to 12 of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, the present invention will be described in more detail as one exemplary embodiment.

The present invention provides a cathode slurry composition for an all-solid-state ion battery including an active material, a conductive material, a sulfide-based solid electrolyte, a binder, and a dispersing solvent, in which the dispersing solvent includes (a) a first dispersing solvent which is at least one selected from a group consisting of cyclopentyl methyl ether, xylene and heptane; (b) a second dispersing solvent which is at least one selected from a group consisting of tributyl amine (TBA), triethylamine and cyclohexanone; and (c) a third dispersing solvent having dispersion of from about 10 MPa to about 20 MPa (e.g., about 10 MPa, 11, 12, 13, 14, 15, 16, 17, 18, 19, or about 20 MPa) and a polarity index of from about 9 MPa to about 18 MPa (e.g., about 9 MPa, 10, 11, 12, 13, 14, 15, 16, 17, or about 18 MPa).

According to a preferred exemplary embodiment of the present invention, the binder may be used for bonding cathode materials such as an active material, a conductive material, and a solid electrolyte. The active material is reduced when the battery is discharged and oxidized when the battery is charged. That is, the volume of the active material is changed when the battery is charged and discharged. As a result, interfacial resistance between cathode materials occurs, and the binder may reduce the interfacial resistance.

As the binder used in the present invention, hydrogenated nitrile butadiene rubber (hereinafter, referred to as ‘HNBR’) in which the nitrile content is from about 20 wt % to about 43 wt % (e.g., about 20 wt %, 21, 22, 23, 24, 25, 26, 27, 28, 29, 30, 31, 32, 33, 34, 35, 36, 37, 38, 39, 40, 41, 42, or about 43 wt %) may be used. The HNBR is obtained by removing a double bond of carbon chains by adding hydrogen to NBR. As a result, the HNBR is chemically stable and has low reactivity with the sulfide-based solid electrolyte. The HNBR is constituted by butadiene repeating units and acrilonitrile repeating units. “%” of the nitrile content means the content of acrilonitrile in the HNBR.

The HNBR may be completely dissolved in the dispersing solvent of the present invention when the nitrile content is about 20 wt % to about 43 wt % (e.g., about 20 wt %, 21, 22, 23, 24, 25, 26, 27, 28, 29, 30, 31, 32, 33, 34, 35, 36, 37, 38, 39, 40, 41, 42, or about 43 wt %). A dielectric constant of the solvent is changed according to the nitrile content and accordingly, the solubility of the HNBR varies. When the HNBR is not dissolved in the solvent, there is a problem in that the HNBR is not evenly dispersed when preparing the cathode to reduce energy density and a lifespan characteristic of the battery. Preferably, the HNBR having the nitrile content of about 20 wt % to about 30 wt % % (e.g., about 20 wt %, 21, 22, 23, 24, 25, 26, 27, 28, 29, or about 30 wt %) may be used.

Herein, the solubility of the HNBR varies according to the nitrile content and may be calculated by the following Equation based on a unique characteristic of the dispersing solvent.

[Equation of Hasen Solubility Parameter]

(Ra)²=4(δ_{d2}−δ_{d1})²+(δₚ₂−δₚ₁)²+(δₕ₂−δₕ₁)²

(In Equation, δ_{d} is dispersion force of the dispersing solvent, δₚ (intermolecular force) is a polarity index of the dispersing solvent, and δₕ is hydrogen bonding force of the dispersing solvent.)

RED=Ra/R₀

(RED<1: The binder is completely dissolved in the dispersing solvent)

(RED=1: The binder is partially dissolved in the dispersing solvent)

(RED>1: The binder is not dissolved in the dispersing solvent)

For example, the solubility of the HNBR may be calculated by substituting cyclopentyl methyl ether (CPME), acrylonitrile, and xylene to the Equation. In this case, the dispersion force of the dispersing solvent is in order of CPME>acrylonitrile>xylene. Further, the polarity index of the dispersing solvent is in order of acrylonitrile>CPME>xylene. Through the Equation, optimized ranges of the nitrile content of the HNBR and unique characteristics (dispersion and a polarity index) of the dispersing solvent may be determined.

According to a preferred exemplary embodiment of the present invention, the dispersing solvent may be a mixture of (a) from about 50 wt % to about 85 wt % (e.g., about 50 wt %, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, or about 85 wt %) of a first dispersing solvent, (b) from about 14 wt % to about 30 wt % (e.g., 14 wt %, 15, 16, 17, 18, 19, 20, 21, 22, 23, 24, 25, 26, 27, 28, 29 or about 30 wt %) of a second dispersing solvent, and (c) from about 1 wt % to about 20 wt % (e.g., about 1 wt %, 2, 3, 4, 5, 6, 7, 8, 9, 10, 11, 12, 13, 14, 15, 16, 17, 18, 19, or about 20 wt %) of a third dispersing solvent. Particularly, when the content of the second dispersing solvent is less than 14 wt %, there is a problem in that dispersion stability of the used cathode slurry deteriorates, and when the content thereof is greater than 30 wt %, there is a problem in that solubility of the used binder deteriorates. Further, when the content of the third dispersing solvent is less than 1 wt %, the binder is not completely dissolved and may be in an opaque state, and when the content thereof is greater than 20 wt %, the lithium ion conductivity of the used sulfide-based solid electrolyte may be decreased.

According to a preferred embodiment of the present invention, the first dispersing solvent is chemically stable because reactivity among the oxygen atoms included in the solvent and the active material, the conductive material, and the sulfide-based solid electrolyte in the slurry is very low and is used for uniformly mixing the components and may partially dissolve the binder. The first dispersing solvent may use at least one selected from a group consisting of cyclopentyl methyl ether, xylene and heptane, of which the polarity index is less than 3 MPa.

According to a preferred embodiment of the present invention, the second dispersing solvent is obtained by mixing the active material, the conductive material, and the sulfide-based solid electrolyte for improving dispersion stability. The second dispersing solvent may use at least one selected from a group consisting of tributyl amine (TBA), triethyl amine, and cyclohexanone, of which the polarity index is from about 3 MPa to about 13 MPa (e.g., about 3 MPa, 4, 5, 6, 7, 8, 9, 10, 11, 12, or about 13 MPa). Particularly, when selecting the second dispersing solvent, by considering the Stoke's law, as illustrated in Table 1 below, there is a method of selecting a dispersing solvent having a large viscosity coefficient of the solvent, selecting a dispersing solvent having a large molecular weight of the binder, or enhancing viscosity of the dispersing solvent with the dissolved binder by increasing the content of binder.

There is a method of using additional additives for reducing a precipitation velocity by decreasing a size of powder or minimizing aggregation of powders by decreasing van der Waals force.

$$U = \frac{{d}^{2} g ( {ρ}_{p} - {ρ}_{f} )}{18 η}$$

U: Precipitation−dependent velocity (cm/sec)
d: Particle size (cm)
Pₚ: Particle density (g/cm²)
P_{f}: Liquid density (g/cm²)
η: Viscosity coefficient of fluid (g/cm·sec)
g: Acceleration of gravity (980 cm/sec²)

TABLE 1

| Classification | Solvent density | | Solvent viscosity coefficient |
|---|---|---|---|
| P-Xylene | 860 | g/cm³ | 0.34 cP |
| O-Xylene | 880 | g/cm³ | 0.812 cP |
| M-Xylene | 870 | g/cm³ | 0.62 cP |
| Heptane | 690~710 | g/cm³ | 0.42 cP |
| Trybutyl Amine | 778 | g/cm³ | 1.35 cP |

According to a preferred embodiment of the present invention, the third dispersing solvent serves to prevent ionization of the sulfide-based solid electrolyte and completely dissolve the HNBR binder. The third dispersing solvent may use a dispersing solvent having dispersion of from about 10 MPa to about 20 MPa (e.g., about 10 MPa, 11, 12, 13, 14, 15, 16, 17, 18, 19, or about 20 MPa) and the polarity index of 9 to 18 MPa (e.g., about 9 MPa, 10, 11, 12, 13, 14, 15, 16, 17, or 18 MPa). The third dispersing solvent may use at least one selected from a group consisting of acetone, methyl ethyl ketone, acetonitrile, dimethylformamide, dimethyl sulfoxide (DMSO), methanol, formic acid, toluene, and water.

Dispersion, the polarity index, and hydrogen bonding force of the dispersing solvents used in the present invention are as illustrated in Table 2 below.

TABLE 2

| | Chemical | δD Dispersion | δP Polar | δH Hydrogen |
|---|---|---|---|---|
| Solvent | formula | (MPa) | (MPa) | bonding (MPa) |
| Cyclopentyl Methyl Ether | C₆H₁₂O | 8.2 | 2.1 | 2.1 |
| (CPME) | | | | |
| Xylene | C₆H₄(CH₃)₂ | 17.8 | 1.0 | 3.1 |
| Heptane | CH₃(CH₂₎₅CH₃ | 7.5 | 0.0 | 0.0 |
| Tributyl amine | C₁₂H₂₇N | 14.6 | 3.7 | 1.9 |
| Triethyl amine | (C₂H₅)₃N | 15.1 | 12.3 | 22.3 |
| Cyclo hexanone | C₆H₁₀(═O) | 17.8 | 6.3 | 5.1 |
| Acetone | CH₃—C(═O)—CH₃ | 15.5 | 10.4 | 7.0 |
| Methyl Ethyl Ketone | CH₃COC₂H₅ | 16.0 | 9.0 | 5.1 |
| Acetonitrile (MeCN) | CH₃—C≡N | 15.3 | 18.0 | 6.1 |
| Dimethylformamide | H—C(═O)N(CH₃)₂ | 17.4 | 13.7 | 11.3 |
| (DMF) | | | | |
| Dimethyl sulfoxide | CH₃—S(═O)—CH₃ | 18.4 | 16.4 | 10.2 |
| (DMSO) | | | | |
| Methanol | CH₃—OH | 14.7 | 12.3 | 22.3 |
| Formic acid | H—C(═O)OH | 14.6 | 10.0 | 14.0 |
| Water | H—O—H | 15.5 | 16.0 | 42.3 |

As illustrated in Table 2, when solvents having a high polarity index among the solvents used in the present invention are used alone, elements of the sulfide-based solid electrolyte may be ionized due to the high polarity index. In the present invention, in order to prevent the problem, it is possible to prevent ionization of the sulfide-based solid electrolyte by using a dispersing solvent including three components having different polarities and simultaneously improve dispersion stability of the active material, the conductive material, and the sulfide-based solid electrolyte.

According to a preferred embodiment of the present invention, the active material may use lithium oxide-based active materials such as lithium nickel cobalt manganese (LiNCM), lithium nickel cobalt aluminum (LiNCA), and lithium iron phosphate (LiFePO₄).

According to a preferred embodiment of the present invention, the conductive material is mixed to be added to the cathode. The all-solid-state ion battery is discharged while electrons contact the active material and then reduction reaction occurs. That is, the electrons need to smoothly move in the cathode. Accordingly, a conductive material having high conductivity for movement of the electrons may be used. The conductive material may use carbon black, Ketjen black, graphite powder, and the like.

According to a preferred embodiment of the present invention, the solid electrolyte is mixed for transferring the movement of lithium ions in the cathode. It is preferred that the solid electrolyte uses a sulfide-based solid electrolyte for a high discharge capacity. As the sulfide-based solid electrolyte, Li₂S, Li₂S—P₂S₅, Li₂S—Ge₂S₂, Li₂S—B₂S₅, Li₂S—Al₂S₅, and the like may be used.

Meanwhile, the cathode for the all-solid-state ion battery of the present invention includes the slurry composition.

The all-solid-state ion battery of the present invention includes the cathode.

Accordingly, the cathode slurry composition of the all-solid-state ion battery according to the present invention can largely improve dispersion and bonding force of the components contained in the cathode slurry by using hydroxylated nitrile butadiene rubber having the nitrile content of from about 20 wt % to about 43 wt % (e.g., about 20 wt %, 21, 22, 23, 24, 25, 26, 27, 28, 29, 30, 31, 32, 33, 34, 35, 36, 37, 38, 39, 40, 41, 42, or 43 wt %) as a binder and a dispersing solvent used by mixing three components having different polarities as a solvent.

In the existing non-polar solvent, the insoluble binder may be completely dissolved and evenly dispersed in the cathode slurry.

It is also possible to prepare a cathode which applies the cathode slurry composition with improved dispersion and bonding force.

It is also possible to improve performance and charge and discharge characteristics of the all-solid-state ion battery using the same.

Hereinafter, the present invention will be described in more detail based on Examples and the present invention is not limited by the following Examples.

### EXAMPLES

The following examples illustrate the invention and are not intended to limit the same.

### Preparation Example: Preparation of Dispersing Solvent

A dispersing solvent added to a cathode slurry composition for an all-solid-state ion battery was prepared with composition components and a content ratio illustrated in Table 3 below.

TABLE 3

| | | Preparation Examples | | | | | | | | |
|---|---|---|---|---|---|---|---|---|---|---|
| Classification (wt %) | | 1 | 2 | 3 | 4 | 5 | 6 | 7 | 8 | 9 |
| First | Cyclopentyl | 100 | 75 | 75 | 75 | 75 | 90 | 75 | — | — |
| dispersing | methyl ether | | | | | | | | | |
| solvent | Xylene | — | — | — | — | — | — | — | 75 | — |
| | Heptane | — | — | — | — | — | — | — | — | 75 |
| Second | Tributyl | — | 25 | — | — | — | — | 15 | 15 | 15 |
| dispersing | amine | | | | | | | | | |
| solvent | | | | | | | | | | |
| Third | Acetone | — | — | 25 | — | — | — | — | — | — |
| dispersing | Methylethyl | — | — | — | 25 | — | — | 10 | 10 | 10 |
| solvent | ketone | | | | | | | | | |
| | Toluene | — | — | — | — | 25 | — | — | — | — |
| | Acetonitrile | — | — | — | — | — | 10 | — | — | — |

### TEST EXAMPLES

### Test Example 1: Evaluation of Solubility of Binder for Each Dispersing Solvent

Evaluation of solubility for each component of dispersing solvents was performed. In the solubility evaluation, respective dispersing solvents illustrated in Table 4 below were used alone and two kinds of binders were injected to 100 ml of each dispersing solvent by 5 g, respectively and dissolved for 5 hours at room temperature and then dissolved states were confirmed.

TABLE 4

| | Binder | | |
|---|---|---|---|
| | Hydroxylated nitrile | | |
| | butadiene rubber | | |
| | having nitrile content | Polyvinylidene | |
| Classification | of 20 wt % | fluoride | Others |
| Triethyl amine | Insoluble | Insoluble | Swelling of binder occurs |
| Tributyl amine | Insoluble | Insoluble | Swelling of binder occurs |
| Acrylonitrile | Insoluble | Partially soluble | Non-dissolved binder exists |
| | | (opaque) | |
| Tetrahydrofuran | Soluble | Soluble | Binder is dissolved, but |
| | | | battery performance |
| | | | deteriorates due to |
| | | | occurrence of side reaction |
| | | | with sulfide-based solid |
| | | | electrolyte |
| Acetonitrile | Insoluble | Insoluble | Swelling of binder occurs |

According to the result in Table 4, it was confirmed that when the respective binders were dissolved by using dispersing solvents in the related art, the binders were insoluble or semi-soluble or swelling of the binders occurred. Further, even though the binders were dissolved, it was confirmed that battery performance deteriorated by generating side reaction with the sulfide-based solid electrolyte.

As a result, it can be seen that because a polarity index is low due to a characteristic of the existing dispersing solvent, the binder components are not dissolved well, whereas when a solvent having a high polarity index is used, the side reaction with the sulfide-based solid electrolyte occurs.

### Test Example 2-1: Result of Measuring Decomposition Degree of Sulfide-Based Solid Electrolyte Including Li, P, and Sn Elements for each Dispersing Solvent (ICP-MS)

The decomposition degree for the sulfide-based solid electrolyte used in the present invention for each dispersing solvent was measured and the results thereof were illustrated in Tables 5 to 7 below.

TABLE 5

| | Test | | | |
|---|---|---|---|---|
| Dispersing solvent | item | Unit | Test result | — |
| TEGMDE(Triethylene | Li | mg/kg | 27.05 | — |
| glycol dimethyl ether) | | (PPM) | | |
| Xylene | | | Undetected | Below limit of |
| | | | | quantitation |
| | | | | (0.033) |
| NMP(N-methyl- | | | 2003 | — |
| pyrrolidone) | | | | |
| Toluene | | | Undetected | Below limit of |
| | | | | quantitation |
| | | | | (0.033) |
| Acetonitrile | | | 319.8 | — |
| Acrylonitrile | | | Undetected | Below limit of |
| | | | | quantitation |
| | | | | (0.033) |
| CPME | | | Undetected | Below limit of |
| | | | | quantitation |
| | | | | (0.033) |
| Acetone | | | 32.9 | — |

TABLE 6

| | Test | | | |
|---|---|---|---|---|
| Dispersing solvent | item | Unit | Test result | — |
| TEGMDE | P | mg/kg | Undetected | Below limit of |
| | | (PPM) | | quantitation |
| | | | | (0.059) |
| Xylene | | | Undetected | Below limit of |
| | | | | quantitation |
| | | | | (0.059) |
| NMP(N-methyl- | | | 1252 | — |
| pyrrolidone) | | | | |
| Toluene | | | 15.85 | — |
| Acetonitrile | | | 193.9 | — |
| Acrylonitrile | | | Undetected | Below limit of |
| | | | | quantitation |
| | | | | (0.059) |
| CPME | | | Undetected | Below limit of |
| | | | | quantitation |
| | | | | (0.059) |
| Acetone | | | 38.6 | — |

TABLE 7

| | Test | | | |
|---|---|---|---|---|
| Dispersing solvent | item | Unit | Test result | — |
| TEGMDE | Sn | mg/kg | Undetected | Below limit of |
| | | (PPM) | | quantitation |
| | | | | (0.192) |
| Xylene | | | Undetected | Below limit of |
| | | | | quantitation |
| | | | | (0.192) |
| NMP(N-methyl- | | | 4211 | — |
| pyrrolidone) | | | | |
| Toluene | | | Undetected | Below limit of |
| | | | | quantitation |
| | | | | (0.192) |
| Acetonitrile | | | 453.0 | — |
| Acrylonitrile | | | Undetected | Below limit of |
| | | | | quantitation |
| | | | | (0.192) |
| CPME | | | Undetected | Below limit of |
| | | | | quantitation |
| | | | | (0.192) |
| Acetone | | | 21.5 | — |

According to the results in Tables 5 to 7, it can be seen that in the case of using a single dispersing solvent for the sulfide-based solid electrolyte including Li, P, and Sn elements, the decomposition degree according to an element of the sulfide-based solid electrolyte for each dispersing solvent varies. Particularly, it was confirmed that when TEGMDE, NMP, acetonitrile, and acetone were used alone, a tendency to ionize the elements of the sulfide-based solid electrolyte was very high. As such, when a dispersing solvent having a high polarity index is used alone, the elements of the sulfide-based solid electrolyte may be ionized by the dispersing solvent and as a result, lithium ion conductivity of the sulfide-based solid electrolyte deteriorates.

### Test Example 2-2: Result of Measuring Decomposition Degree of Sulfide-Based Solid Electrolyte Including Li, P, and Sn Elements for each Mixed Dispersing Solvent (ICP-MS)

The decomposition degree for the sulfide-based solid electrolyte used in the present invention for each dispersing solvent was measured and the results thereof were illustrated in Table 8 to 10 below.

TABLE 8

| | Test | | | |
|---|---|---|---|---|
| Dispersing solvent | item | Unit | Test result | — |
| Acetone 100 wt % | Li | mg/kg | 32.9 | — |
| Acetone 99 wt % | | (PPM) | Undetected | Below limit of |
| CPME 1 wt % | | | | quantitation (0.033) |
| Acetone 97 wt % | | | | |
| CPME 3 wt % | | | | |
| Acetone 95 wt % | | | | |
| CPME 5 wt % | | | | |
| Acetone 93 wt % | | | | |
| CPME 7 wt % | | | | |
| Acetone 90 wt % | | | | |
| CPME 10 wt % | | | | |
| CPME 100 wt % | | | | |

TABLE 9

| | Test | | | |
|---|---|---|---|---|
| Dispersing solvent | item | Unit | Test result | — |
| Acetone 100 wt % | P | mg/kg | 38.6 | — |
| Acetone 99 wt % | | (PPM) | Undetected | Below limit of |
| CPME 1 wt % | | | | quantitation (0.059) |
| Acetone 97 wt % | | | | |
| CPME 3 wt % | | | | |
| Acetone 95 wt % | | | | |
| CPME 5 wt % | | | | |
| Acetone 93 wt % | | | | |
| CPME 7 wt % | | | | |
| Acetone 90 wt % | | | | |
| CPME 10 wt % | | | | |
| CPME 100 wt % | | | | |

TABLE 10

| | Test | | | |
|---|---|---|---|---|
| Dispersing solvent | item | Unit | Test result | — |
| Acetone 100 wt % | Sn | mg/kg | 21.5 | — |
| Acetone 99 wt % | | (PPM) | Undetected | Below limit of |
| CPME 1 wt % | | | | quantitation (0.192) |
| Acetone 97 wt % | | | | |
| CPME 3 wt % | | | | |
| Acetone 95 wt % | | | | |
| CPME 5 wt % | | | | |
| Acetone 93 wt % | | | | |
| CPME 7 wt % | | | | |
| Acetone 90 wt % | | | | |
| CPME 10 wt % | | | | |
| CPME 100 wt % | | | | |

According to the results in Tables 8 to 10, as compared with the result in Test Example 2-1 using the dispersing solvent alone, it was confirmed that when a mixed dispersing solvent of two components was used, decomposition (ionization) of the elements of the sulfide-based solid electrolyte was prevented.

### Test Example 3: Evaluation of Binder Solubility using Dispersion Solvents in Preparation Examples 1 and 6

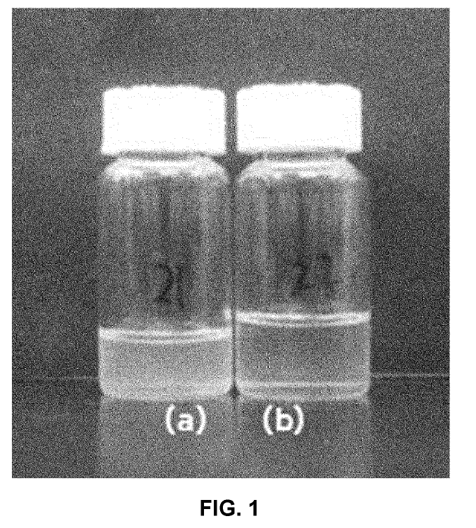

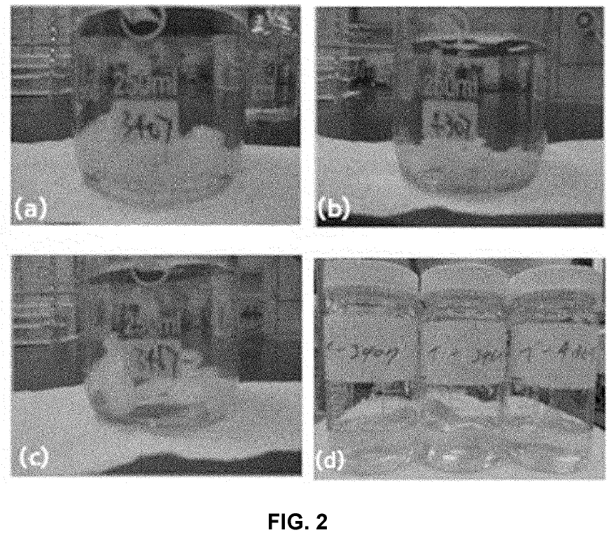

Evaluation of binder solubility using dispersion solvents in Preparation Examples 1 and 6 was performed. In the solubility evaluation test, 5 g of a binder was mixed in 100 ml of each dispersing solvent and then dissolved for 5 hours at room temperature, and then a dissolved state was confirmed. The results were illustrated in FIGS. 1 and 2. The binder used a HNBR binder of which the nitrile content was 20 wt %, 34 wt %, 39 wt %, and 43 wt %.

FIG. 1 is a photograph illustrating a result of evaluating solubility of an HNBR binder (34 wt % and 20 wt % of nitrile) for a dispersing solvent in Preparation Example 1. FIG. 1A was a case of using the HNBR binder containing 34 wt % of nitrile, and it was confirmed that the binder was insoluble in the dispersing solvent in Preparation Example 1 to be opaque. Particularly, as a result of quantifying the suspended solids of the solution (a) by using a centrifuge, it was confirmed that 99.1 wt % of the binder was dissolved and the remaining 0.09 wt % was insoluble to be suspended. Further, FIG. 1B was a case of using the HNBR binder containing 20 wt % of nitrile, and it was confirmed that the binder was not completely dissolved and still present in an opaque state.

FIG. 2 is a photograph illustrating a result of evaluating solubility of an HNBR binder (34 wt %, 39 wt %, and 43 wt % of nitrile) for dispersing solvents in Preparation Examples 1A to 1C and 6D. As illustrated in FIG. 2, in the case of FIGS. 2A to 2C using the first dispersing solvent alone, it was confirmed that the HNBR binder was not completely dissolved to be in an insoluble state. On the other hand, in the case of FIG. 2D of mixing dispersing solvents of two components having different polarity indexes, it was confirmed that the HNBR binder was completely dissolved. However, in FIG. 2D, the HNBR binder was dissolved, but has a very strong polarity index to ionize the elements of the sulfide-based solid electrolyte, and as a result, there is a problem in that the lithium ion conductivity of the sulfide-based solid electrolyte deteriorates.

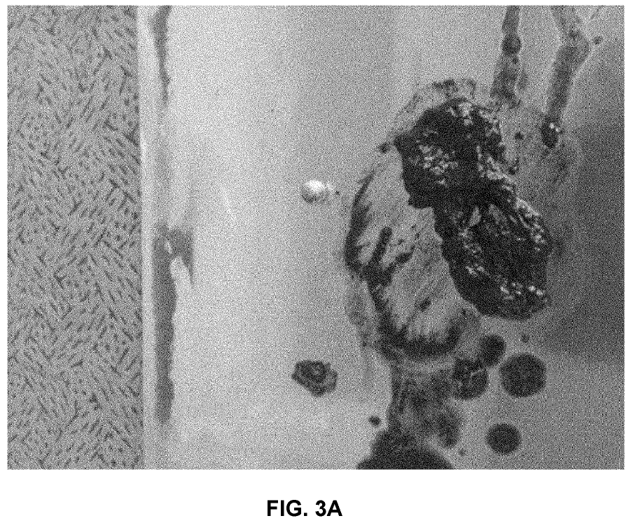

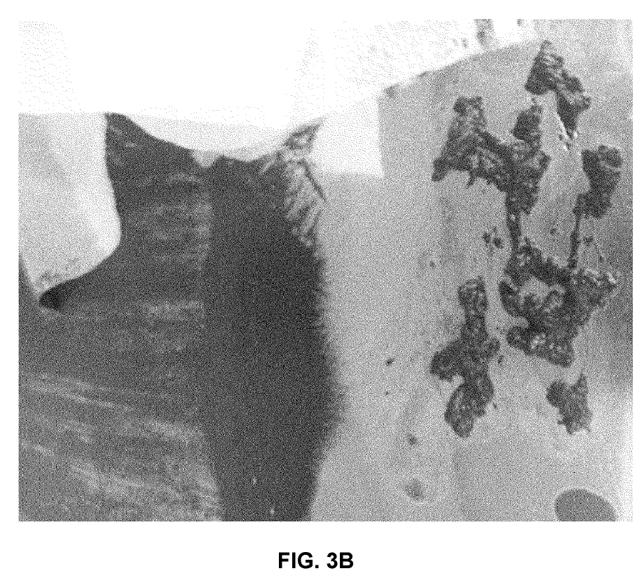

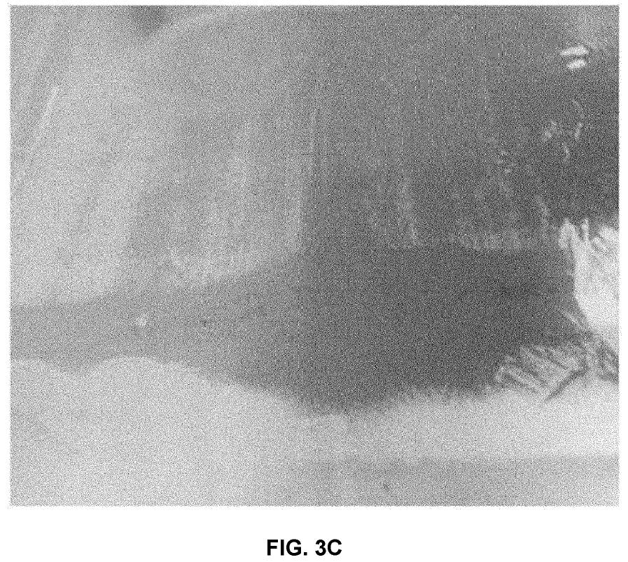

FIGS. 3A to 3C are photographs illustrating results of evaluating solubility of HNBR binders (34 wt %, 39 wt %, and 43 wt % of nitrile) for a dispersing solvent in Preparation Example 2. As illustrated in FIGS. 3A and 3B, for improving the dispersion, the second dispersing solvent was mixed and used with the first dispersing solvent capable of completely or partially dissolving the binder, but it is confirmed that there is a problem in that the HNBR binder is eluted.

As confirmed in FIG. 3C, there is a problem in that dispersion and stability of the slurry are broken by eluting the binder and the electrodes are not formed well.

As a result, when selecting the second dispersing solvent which is additionally mixed for improving the dispersion, the second dispersing solvent needs to be selected by considering the problems, and a need of mixing the third dispersing solvent for compensating for the problems is on the rise.

### Test Example 4: Evaluation of Binder Solubility using Dispersion Solvents in Preparation Examples 1 to 5 and 7 to 9

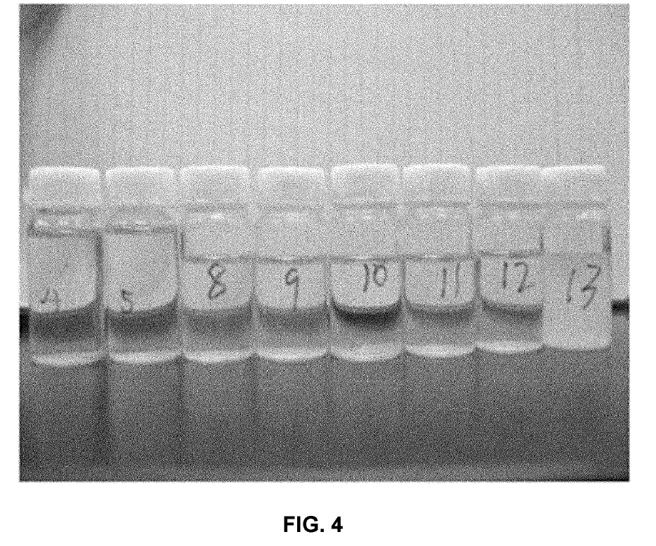

Evaluation of binder solubility using dispersion solvents in Preparation Examples 1 to 5 and 7 to 9 was performed. In the solubility evaluation test, 5 g of a binder was mixed in 100 ml of each dispersing solvent and then dissolved for 5 hours at room temperature, and then a dissolved state was confirmed. The results are as illustrated in Table 11 and FIG. 4 below.

TABLE 11

| | | Example | | | | | | | |
|---|---|---|---|---|---|---|---|---|---|
| Classification | | 1 | 2 | 3 | 4 | 5 | 6 | 7 | 8 |
| HNBR | 20 | Completely | Completely | Completely | Soluble | Insoluble | Soluble | Soluble | Insoluble |
| binder | wt | soluble | soluble | soluble | (opaque) | | (opaque) | (opaque) | |
| (nitrile | % | | | | | | | | |
| content | 34 | Completely | Completely | Completely | Soluble | Insoluble | Soluble | Soluble | Partially |
| | wt | soluble | soluble | soluble | (opaque) | (occurrence | (opaque) | (opaque) | soluble |
| | % | | | | | of precipitate) | | | |
| | 39 | Completely | Completely | Completely | Partially | Insoluble | Partially | Partially | Insoluble |
| | wt | soluble | soluble | soluble | soluble | | soluble | soluble | |
| | % | | | | | | | | |
| | 43 | Completely | Completely | Completely | Insoluble | Insoluble | Insoluble | Insoluble | Insoluble |
| | wt | soluble | soluble | soluble | | | | | |
| | % | | | | | | | | |
| Dispersing | | Preparation | Preparation | Preparation | Preparation | Preparation | Preparation | Preparation | Preparation |
| solvent | | Example | Example | Example | Example | Example | Example | Example | Example |
| | | 7 | 8 | 9 | 3 | 1 | 4 | 5 | 2 |

According to the result in Table 11, in the case of Examples 1 to 3 of mixing dispersing solvents of three components having different polarity indexes, it was confirmed that HNBR binders containing nitrile of 20 to 43 wt % were completely dissolved.

On the other hand, in case of Examples 4 to 8 of mixing the dispersing solvents of two components, it was confirmed that the HNBR binder was dissolved, but dissolved in an opaque state and partially dissolved or insoluble.

FIG. 4 is a photograph illustrating a result of evaluating solubility of an HNBR binder (34 wt % of nitrile) using dispersing solvents in Preparation Examples 1 to 5 and 7 to 9. In FIG. 4, the results of Examples 1 to 8 (Nos. 4, 5, and 8 to 13 of FIG. 4) were listed in sequence.

As confirmed in FIG. 4, in the case of Examples 1 to 3 of mixing and using three components having different polarity indexes as compared with the case of using the dispersing solvent alone or mixing and using two components, it was confirmed that the HNBR binder was completely dissolved. In addition, under the same condition, when the HNBR binder was maintained as it is in the completely dissolved state when being left for 1 week, it was found that the HNBR binder component was not sunken at all.

On the other hand, in Examples 4 to 8, it was confirmed that the HNBR binder was in an insoluble state, partially dissolved or dissolved in an opaque state. Further, under the same condition, when the HNBR binder was partially dissolved or dissolved in the opaque state when being left for 1 week, it was confirmed that the HNBR binder component was sunken at the bottom.

As a result, like the present invention, when mixing and using three components having different polarity indexes as compared with the case of using the dispersing solvent alone or mixing and using two components, the HNBR binder is completely dissolved. In addition, it can be seen that the ionization of the elements of the sulfide-based solid electrolyte is prevented and dispersion stability is excellent and thus the cathode active material, the conductive material, and the like are evenly dispersed.

### Test Example 5: Evaluation of Charge/Discharge and Lifespan Characteristics of All-Solid-State Ion Battery

Cathode slurry for an all-solid-state ion battery having the solid content of 60 wt % was prepared with composition components and a content ratio illustrated in Table 12 below.

TABLE 12

| Classification | | Example 9 | Example 10 | Example 11 | Example 12 |
|---|---|---|---|---|---|
| Cathode active | NCM | 70 | 70 | 70 | 70 |
| material (wt %) | | | | | |
| Sulfide-based | LiSPSn | 30 | 30 | 30 | 30 |
| solid electrolyte | | | | | |
| (wt %) | | | | | |
| Conductive | Super C | 5 | 5 | 5 | 5 |
| material | | | | | |
| (wt %) | | | | | |
| HNBR binder | Containing | 3 | 3 | 3 | 3 |
| (wt %) | 34 wt % of | | | | |
| | nitrile | | | | |

| | | | | |
|---|---|---|---|---|
| Dispersing solvent | Preparation | Preparation | Preparation | Preparation |
| | Example 1 | Example 2 | Example 3 | Example 8 |

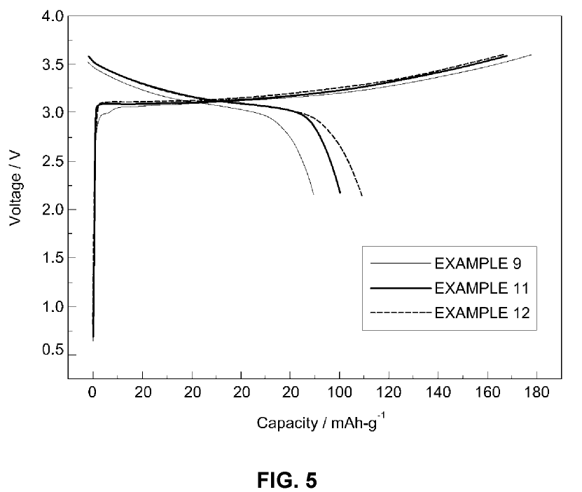

The all-solid-state ion battery was prepared by a general method using the cathode slurry. In the all-solid-state ion battery prepared above, evaluation of charge and discharge was performed under a condition of 2 to 4.3 V (voltage) and 0.02 mA/cm² (current density), and the results were illustrated in FIG. 5.

FIG. 5 is a graph illustrating a result of evaluating charge and discharge of the all-solid-state ion battery prepared in Examples 9 to 12. As confirmed in FIG. 5, in Example 10, it was difficult to measure charge and discharge efficiency of the all-solid-state ion battery due to the elution of the HNBR binder, and in Example 9, it was confirmed that discharge efficiency was not unfavorable.

On the other hand, in Examples 11 and 12, it was confirmed that the binder was completely dissolved and the active material, the conductive material, and the like were evenly dispersed in the cathode slurry and thus the charge and discharge efficiency of the all-solid-state ion battery was largely improved due to the cathode slurry with improved dispersion and bonding force.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A cathode slurry composition for an all-solid-state ion battery comprising
an active material, a conductive material, a sulfide-based solid electrolyte, a binder, and a dispersing solvent,
wherein the dispersing solvent comprises:
(a) a first dispersing solvent which is at least one selected from a group consisting of cyclopentyl methyl ether, xylene and heptane;
(b) a second dispersing solvent which is at least one selected from a group consisting of tributyl amine (TBA), triethylamine and cyclohexanone; and
(c) a third dispersing solvent having dispersion of from about 10 to about 20 MPa and a polarity index of from about 9 to about 18 MPa.

2. The cathode slurry composition of claim 1, wherein the dispersing solvent is a mixture of (a) about 50 to about 85 wt % of a first dispersing solvent, (b) about 14 to about 30 wt % of a second dispersing solvent, and (c) about 1 to about 20 wt % of a third dispersing solvent.

3. The cathode slurry composition of claim 1, wherein the third dispersing solvent is at least one selected from a group consisting of acetone, methyl ethyl ketone, acetonitrile, dimethylformamide, dimethyl sulfoxide, methanol, formic acid, toluene, and water.

4. The cathode slurry composition of claim 1, wherein the binder is hydrogenated nitrile butadiene rubber (HNBR) having the nitrile content of about 20 to about 43 wt %.

5. A cathode for an all-solid-state ion battery comprising the cathode slurry composition of claim 1.

6. An all-solid-state ion battery comprising the cathode of claim 5.
